(19) United States
(12) Patent Application Publication
(10) Pub. No.: US 2017/0185792 A1
(43) Pub. Date: Jun. 29, 2017

(54) MOBILE TERMINAL, DISPLAYING SYSTEM, DISPLAY CONTROLLING METHOD, AND RECORDING MEDIUM

(71) Applicant: NEC Corporation, Tokyo (JP)

(72) Inventors: Kenichiro FUJII, Tokyo (JP); Tatsuyuki SHINTANI, Tokyo (JP); Chika MIYATAKE, Tokyo (JP)

(73) Assignee: NEC Corporation, Tokyo (JP)

(21) Appl. No.: 15/129,343

(22) PCT Filed: Jan. 21, 2015
(86) PCT No.: PCT/JP2015/051534

§ 371 Date: Sep. 26, 2016

(30) Foreign Application Priority Data
Mar. 27, 2014 (JP) 2014-065719

(51) Int. Cl. G06F 21/62

(52) U.S. Cl. CPC G06F 21/6218

(57) ABSTRACT

Mobile terminal (10) includes display section (103) that has a display maintenance property that eliminates the need to rely on electricity for retaining displayed contents, sensing section (107) that senses whether or not predetermined terminal device (20) is present within a predetermined range, and a display control section (108) that causes the display section (103) to display a predetermined image when the terminal device (20) is present outside the predetermined range.

### TECHNICAL FIELD

The present invention relates to a mobile terminal, a displaying system, a display controlling method, and a program.

### BACKGROUND ART

In recent years, there have been proposed various methods for inhibiting leakage of information stored in a mobile terminal such as a mobile phone, a smartphone, and a tablet terminal, in the case of losing the mobile terminal. For example, Patent Literature 1 discloses a data management system that deletes data stored in a storage section of a mobile phone device when the distance from a slave device becomes greater than a predetermined value. With this configuration, when the mobile phone device is lost, information is deleted, and thus it is possible to inhibit leakage of the information even when an owner of the mobile phone device does not notice the loss.

### CITATION LIST

### Patent Literature

Patent Literature 1: JP2009-239704A

### SUMMARY OF INVENTION

### Technical Problem

However, there is a problem with the method described in Patent Literature 1 in that leakage of information cannot be inhibited in some cases. For example, there is a case where display content continues to be retained even after information that is stored in the storage section has been deleted, such as a case where a display section of a mobile terminal is a display section that has display maintenance property that eliminates the need to rely on electricity for retaining displayed contents. In this case, the information remains displayed on the display section, and thus it is not possible to inhibit leakage of the information.

An objective of the present invention is to provide a mobile terminal, a displaying system, a display controlling method, and a program that are capable of inhibiting leakage of information more reliably.

### Solution to Problem

A mobile terminal according to the present invention includes:

a display section:

a distance sensing section that senses whether or not a predetermined terminal device is present within a predetermined range; and

a display control section that causes the display section to display a predetermined image when the terminal device is present outside the range.

In addition, a displaying system according to the present invention is

a displaying system using a paired first mobile terminal and second mobile terminal, wherein

the second mobile terminal includes:

a display section;

a sensing section that senses whether or not the first mobile terminal is present within a predetermined range; and

a display control section that causes the display section to display a predetermined image when the first mobile terminal is present outside the range.

In addition, a display controlling method according to the present invention includes:

sensing whether or not a first mobile terminal is present within a predetermined range with respect to a second mobile terminal that includes a display section; and

displaying a predetermined image on the display section when the first mobile terminal is present outside the range.

In addition, a recording medium according to the present invention is a recording medium in which a program is stored, the program causing a computer to execute the steps of:

sensing whether or not a first mobile terminal is present within a predetermined range with respect to a second mobile terminal that comprises a display section; and

displaying a predetermined image on the display section when the first mobile terminal is present outside the range.

### Advantageous Effect of Invention

According to the present invention, it is possible to inhibit leakage of information more reliably.

### BRIEF DESCRIPTION OF DRAWINGS

FIG. 1 is a block diagram illustrating the configuration of electronic paper terminal 10 according to a first exemplary embodiment.

FIG. 2 is a flowchart for describing an operation example of electronic paper terminal 10 in FIG. 1.

FIG. 3 is a block diagram illustrating the configuration of smartphone 20 according to a second exemplary embodiment.

FIG. 4 is a sequence diagram for describing an operation example of data management system 2 according to the second exemplary embodiment.

### DESCRIPTION OF EMBODIMENTS

Hereinafter, embodiments will be described with reference to the accompanying drawings. It is noted that, in the present specification and the drawings, components having the same function will be denoted by the same reference numeral, and duplicated description thereof may be omitted.

### First Exemplary Embodiment

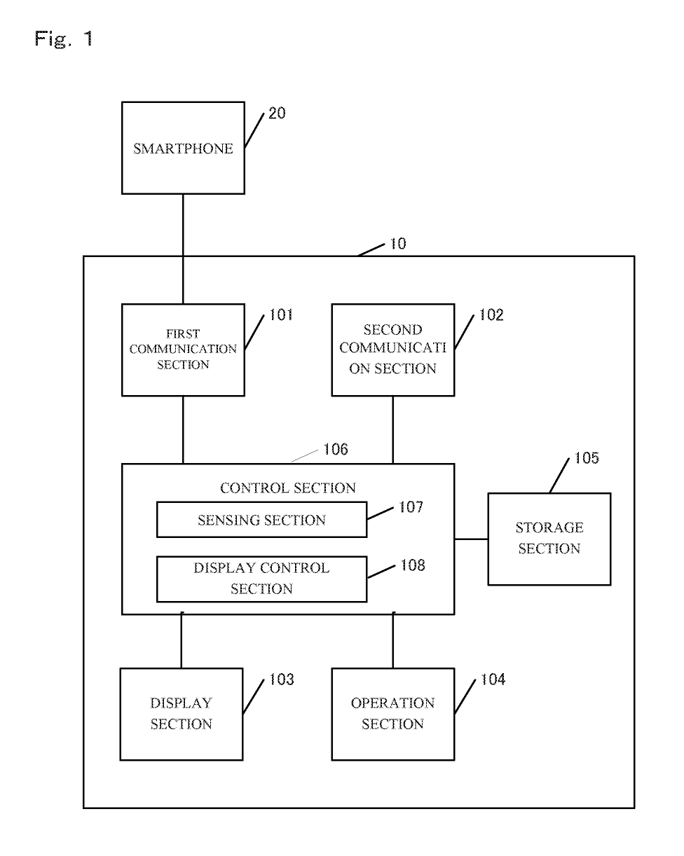

FIG. 1 is a block diagram illustrating the configuration of electronic paper terminal 10 according to a first exemplary embodiment.

Electronic paper terminal 10 according to the present exemplary embodiment is an example of a mobile terminal including a display section that has a display maintenance property. Electronic paper terminal 10 includes, as illustrated in FIG. 1, first communication section 101, second communication section 102, display section 103, operation section 104, storage section 105, and control section 106.

First communication section 101 includes a communication interface or the like that complies with a first telecommunications standard and that performs wireless communication with an external device such as smartphone 20 under instructions from control section 106. The first telecommunications standard is, for example, a near field radio communication standard such as near field communication (NFC) and Bluetooth (R).

Second communication section 102 includes an antenna or a communication interface or the like that complies with a second telecommunications standard and that performs wireless communication with an external device, under instructions from control section 106. Second communication section 102 includes a communication interface that makes a connection with, for example, a mobile network.

Display section 103 includes an electronic paper sheet and displays various images, under instructions from control section 106. Display section 103 has a display maintenance property that eliminates the need to rely on electricity for retaining displayed contents.

Operation section 104 includes a touch panel or an operating button. In addition, operation section 104 receives an operation made by a user, generates an operating signal corresponding to the received operation, and outputs the operating signal to control section 106.

Storage section 105 is a device for data storage and includes, for example, a nonvolatile memory such as a flash memory, or a magnetic recording medium such as a hard disk drive (HDD). Storage section 105 stores, for example, a program that causes electronic paper terminal 10 to operate, and data to be displayed on display section 103.

Control section 106 is a microprocessor or the like. Control section 106 reads and executes the program stored in storage section 105 to implement functions of, for example, sensing section 107 and display control section 108, and controls the operation of electronic paper terminal 10.

Sensing section 107 senses, using first communication section 101, whether or not smartphone 20 is present within a predetermined range with respect to electronic paper terminal 10. Specifically, the predetermined range is a range within which first communication section 101 can perform communication, and sensing section 107 polls smartphone 20 using first communication section 101 and determines whether or not smartphone 20 is present within the range in which smartphone 20 can communicate with first communication section 101. Upon succeeding in polling smartphone 20, sensing section 107 determines that smartphone 20 is present within the predetermined range. On the other hand, upon failing to poll smartphone 20, sensing section 107 determines that smartphone 20 is present outside the predetermined range. Upon sensing that smartphone 20 is present outside the predetermined range, sensing section 107 notifies display control section 108 of the fact.

Display control section 108 controls a display content using display section 103. Upon receiving, from sensing section 107, the fact that smartphone 20 is present outside the predetermined range, display control section 108 rewrites the displayed contents of display section 103 to cause a predetermined image to be displayed. The predetermined image may be, for example, a white image, a black image, a predetermined desktop image, a sleep image that is displayed in a sleeping state, or the like. Alternatively, the predetermined image may be a specific image that is displayed when smartphone 20 is present outside the predetermined range. When smartphone 20 is present outside the predetermined range, it is considered as a state where electronic paper terminal 10 or smartphone 20 is apart from an owner to be lost. For this reason, the specific image may be an image containing information that is preset by the owner, for example, information on a contact address of the owner.

In addition, display control section 108 stores data to be displayed on display section 103 in storage section 105 upon acquiring the data from smartphone 20. Then, upon causing display section 103 to display the data stored in storage section 105, display control section 108 deletes the displayed data from storage section 105. Since display section 103 has the display maintenance property, the displayed contents of display section 103 is retained until the display is rewritten, even after the data is deleted from storage section 105.

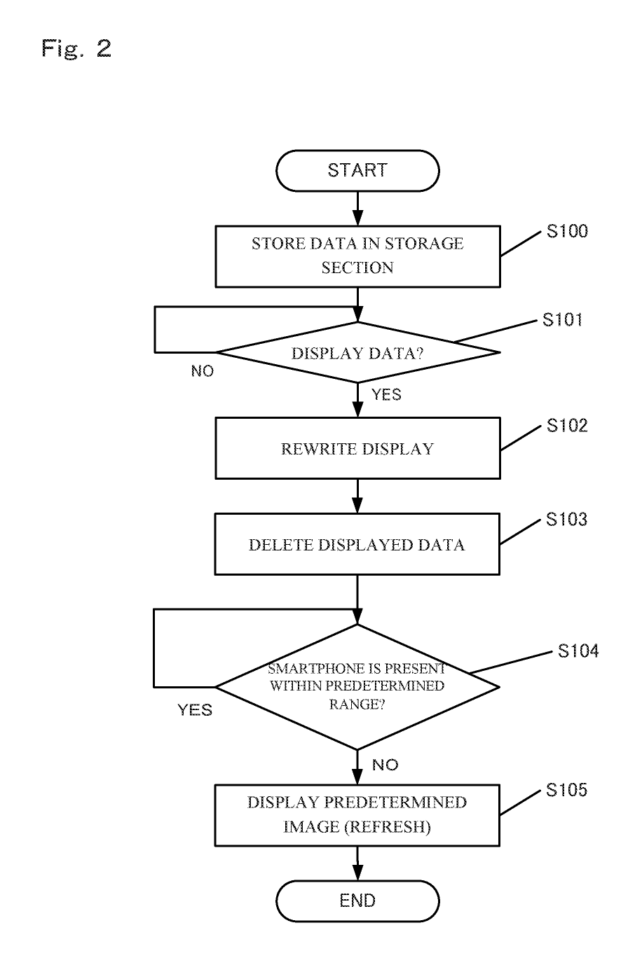

FIG. 2 is a flowchart for describing an operation example of electronic paper terminal 10 in FIG. 1.

Display control section 108 of electronic paper terminal 10 stores data in storage section 105. For example, display control section 108 can acquire data from an external device through first communication section 101 or second communication section 102 and can store the acquired data in storage section 105 (step 100).

Subsequently, display control section 108 determines whether to cause display section 103 to display the data stored in storage section 105. For example, in response to an operating signal output by operation section 104, display control section 108 determines whether or not an operation to cause display section 103 to display data has been performed, and determines, based on the determination result, whether to cause display section 103 to display the data (step 101).

When display section 103 is caused to display data, display control section 108 causes display section 103 to rewrite the displayed contents and display data stored in storage section 105 (step 102). When the displayed contents of display section 103 is rewritten, display control section 108 deletes the displayed data from storage section 105 (step 103).

In addition, sensing section 107 determines whether or not smartphone 20 is present within the predetermined range. Specifically, sensing section 107 polls smartphone 20 using first communication section 101 and determines, based on whether or not the polling has succeeded, whether or not smartphone 20 is present within the predetermined communicable range (step 104).

When smartphone 20 is present outside the predetermined range, sensing section 107 notifies the display control section 108 of the fact. Then, upon receiving the fact, display control section 108 causes display section 103 to display the predetermined image (step 105). On the other hand, when smartphone 20 is present within the predetermined range, sensing section 107 continues the determination of whether or not smartphone 20 is present within the predetermined range.

As described above, according to the first exemplary embodiment, electronic paper terminal 10, which is an example of a mobile terminal, includes display section 103, sensing section 107, and display control section 108. Sensing section 107 senses whether or not smartphone 20, which is a predetermined terminal device, is present within the predetermined range. In addition, when smartphone 20 is present outside the predetermined range, display control section 108 causes display section 103 to display the predetermined image. With this configuration, for example, when electronic paper terminal 10 is lost and the distance between electronic paper terminal 10 and smartphone 20 becomes a predetermined threshold value or more, the displayed contents is rewritten, and the predetermined image is displayed. It is therefore possible to inhibit leakage of information more reliably.

In addition, according to the above exemplary embodiment, electronic paper terminal 10 includes storage section 105 that stores data to be displayed on display section 103, and display section 103 has the display maintenance property of retaining a display content without using electricity. Upon causing the display section 103 to display data stored in storage section 105, display control section 108 deletes the displayed data from storage section 105. With this configuration, the data displayed on display section 103 is deleted from storage section 105 and cannot be taken out. In the case where display section 103 has the display maintenance property, when data is displayed on display section 103, the data is brought into a state where it is not used to retain the displayed contents. This makes a time for which data is stored in storage section 105 short as compared to deleting the data in storage section 105 when the distance between electronic paper terminal 10 and smartphone 20 becomes the threshold value or more. It is thereby possible for a mobile terminal equipped with a display section having the display maintenance property to inhibit leakage of information more reliably.

Note that, in the case where an image on display section 103 is erased without deleting data in storage section 105, when smartphone 20 is again present within the predetermined range, and electronic paper terminal 10 and smartphone 20 are paired again, the image can be displayed immediately without exchanging data again.

In addition, according to the above exemplary embodiment, the predetermined image displayed at the time when smartphone 20 is present outside the predetermined range contains contact address information of an owner of electronic paper terminal 10. With this configuration, when the owner of electronic paper terminal 10 loses electronic paper terminal 10, the contact address information of the owner is displayed on display section 103. Therefore, when the lost electronic paper terminal 10 is picked up by another person, the person picking up electronic paper terminal 10 can make contact with the owner. It is therefore possible to increase the possibility that electronic paper terminal 10 will be returned to the owner when electronic paper terminal 10 is lost.

### Second Exemplary Embodiment

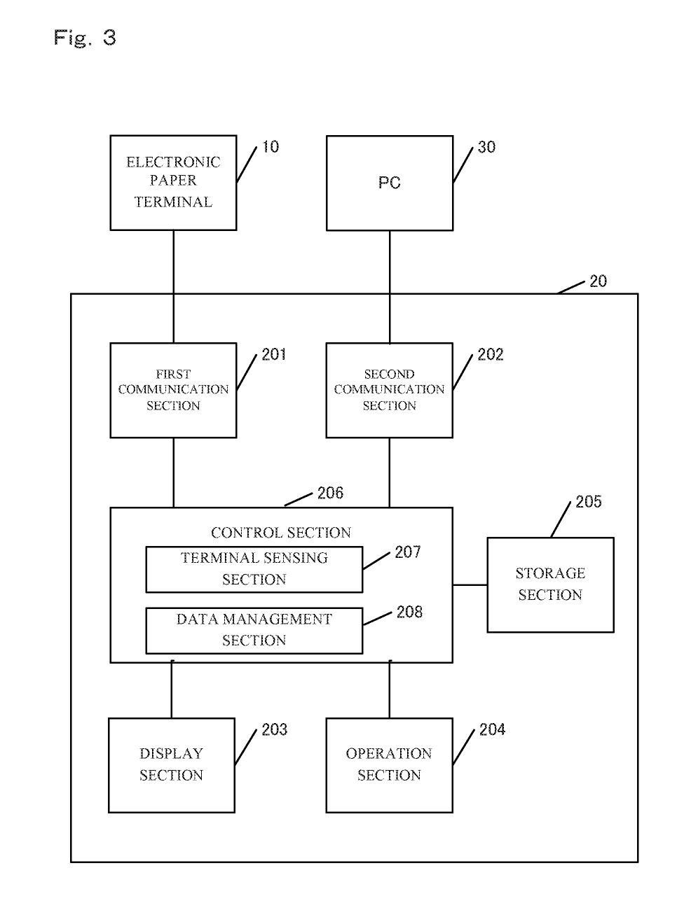

FIG. 3 is a block diagram illustrating the configuration of data management system 2 according to a second exemplary embodiment and the detailed configuration of smartphone 20.

Data management system 2 in the present exemplary embodiment includes, as illustrated in FIG. 2, electronic paper terminal 10, smartphone 20, and personal computer (PC) 30. Electronic paper terminal 10 has the same configuration as in FIG. 1. The configuration of electronic paper terminal 10 will be described below with reference to FIG. 1, mainly about parts different from those in the first exemplary embodiment.

Display control section 108 of electronic paper terminal 10 acquires data to be displayed on display section 103 from smartphone 20 with display section 103 displaying page units one at a time. Specifically, display control section 108 acquires data on a material file from smartphone 20 page by page and causes display section 103 to display the data. When an operating signal output by operation section 104 indicates a page changing operation, display control section 108 acquires, from smartphone 20, data on a page of the material displayed on display section 103 corresponding to the page changing operation and rewrites the displayed contents of display section 103.

Return to the description of FIG. 3. Smartphone 20 illustrated in FIG. 3 is an example of a paired first mobile terminal, and electronic paper terminal 10 is an example of a second mobile terminal paired with smartphone 20. Smartphone 20 includes first communication section 201, second communication section 202, display section 203, operation section 204, storage section 205, and control section 206.

First communication section 201 includes a communication interface or the like that complies with the first telecommunications standard. First communication section 201 performs wireless communication with an external device such as electronic paper terminal 10, under instructions from control section 206.

Second communication section 202 includes a communication interface or the like that complies with the second telecommunications standard. Second communication section 202 performs wireless communication with an external device, under instructions from control section 206. Second communication section 202 includes a communication interface that makes a connection with, for example, a mobile network.

Display section 203 displays various images under instructions from control section 206. Display section 203 is, for example, a liquid crystal display (LCD) or the like.

Operation section 204 includes a touch panel or an operating button. Operation section 204 receives an operation made by a user, generates an operating signal corresponding to the received operation, and outputs the operating signal to control section 206.

Storage section 205 is a device for data storing. Storage section 205 includes, for example, a nonvolatile memory such as a flash memory, or a magnetic recording medium such as a hard disk drive (HDD). Storage section 205 stores, for example, a program that causes smartphone 20 to operate, and a material file.

Control section 206 is a microprocessor or the like. Control section 206 reads and executes the program stored in storage section 205 to implement functions of, for example, terminal sensing section 207 and data management section 208, and controls the operation of smartphone 20.

Terminal sensing section 207 senses, using first communication section 201, whether or not electronic paper terminal 10 is present within a specific range with respect to smartphone 20. Specifically, the specific range is a range within which first communication section 201 can perform communication. Then, terminal sensing section 207 polls electronic paper terminal 10 using first communication section 201 to determine whether or not electronic paper terminal 10 is present within the specific range. After successfully in polling electronic paper terminal 10, terminal sensing section 207 determines that electronic paper terminal 10 is present within the specific range. On the other hand, upon failing to poll, terminal sensing section 207 determines that electronic paper terminal 10 is present outside the specific range. Upon sensing that electronic paper terminal 10 is present outside the specific range, terminal sensing section 207 notifies data management section 208 of the fact.

Data management section 208 manages data stored in storage section 205. Upon acquiring a material file from PC 30 using second communication section 202, for example, data management section 208 stores the material file in storage section 205. In addition, data management section 208 transmits, to electronic paper terminal 10, a material list in which materials stored in storage section 205 are enumerated. Then, when some material in the material list is selected, and data on the material is requested, data management section 208 converts the data format of the requested material, and transmits the data to electronic paper terminal 10 page by page. In addition, upon receiving a page changing request from electronic paper terminal 10, data management section 208 transmits data on the requested page to electronic paper terminal 10.

In addition, upon receiving, from terminal sensing section 207, the fact that electronic paper terminal 10 is present outside the specific range, data management section 208 deletes the data on the material file stored in storage section 205. At this point, data management section 208 may delete all of the material file stored in storage section 205, or may delete part of the material file. In the case where a material file is attached with a tag or the like indicating that the material file is information that has to be kept secret from everyone except for the person concerned, data management section 208 can also selectively delete information attached with this tag. In addition, upon receiving the fact that electronic paper terminal 10 is present outside the specific range, data management section 208 can also transmit a warning message to the PC 30.

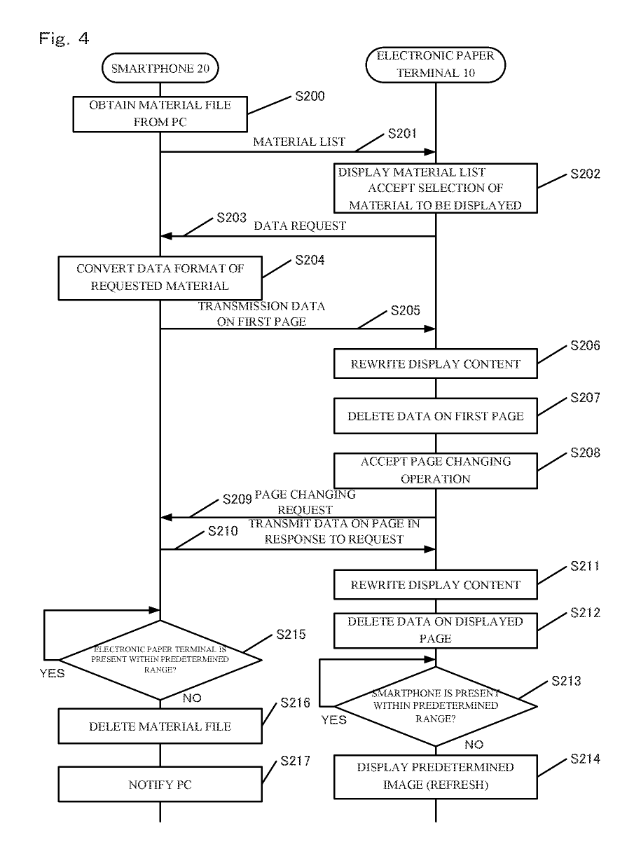

FIG. 4 is a sequence diagram for describing an operation example of data management system 2.

Data management section 208 of smartphone 20 obtains a material file from PC 30 using second communication section 202 and stores the material file in storage section 205 (step 200). Then, data management section 208 transmits a material list, in which material files stored in storage section 205 are enumerated, to electronic paper terminal 10 (step 201).

Upon receiving the material list, display control section 108 of electronic paper terminal 10 causes display section 103 to display the received material list. Then, display control section 108 is brought into a state of receiving a selection of individual materials contained in the material list (step 202). Upon receiving an operating signal indicating that some material is selected from the material list, display control section 108 transmits a data request to request data on material indicated by the operating signal, to smartphone 20 (step 203).

Upon receiving the data request from electronic paper terminal 10, data management section 208 of smartphone 20 converts the data format of the requested material. Specifically, data management section 208 generates data on each page based on the material file (step 204). Then, data management section 208 transmits data on the first page of the material file, to electronic paper terminal 10 (step 205).

Upon receiving the data on the first page, display control section 108 of electronic paper terminal 10 stores the received data in storage section 105, and rewrites displayed contents based on this data (step 206). Upon rewriting the display content, display control section 108 deletes the data on the first page from storage section 105 (step 207). Then, operation section 104 receives a page changing operation, and outputs an operating signal corresponding to the page changing operation to control section 106 (step 208).

Upon receiving the operating signal corresponding to the page changing operation, display control section 108 transmits a page changing request to request data on a page corresponding to the page changing operation, to smartphone 20 (step 209).

Upon receiving the page changing request, data management section 208 of smartphone 20 transmits the data on the page corresponding to the received page changing request, to electronic paper terminal 10 (step 210).

Upon receiving the data from smartphone 20, display control section 108 of electronic paper terminal 10 stores the received data in storage section 105 and rewrites the displayed contents based on this data (step 211). Then, upon rewriting the displayed contents, display control section 108 deletes the data on the displayed page from storage section 105 (step 212).

In addition, sensing section 107 determines whether or not smartphone 20 is present within the predetermined range (step 213). When smartphone 20 is present outside the predetermined range, sensing section 107 notifies display control section 108 of the fact that smartphone 20 is present outside the predetermined range. Upon receiving notification of the fact, display control section 108 causes display section 103 to display the predetermined image (step 214). When smartphone 20 is present within the predetermined range, sensing section 107 repeats the determination of whether or not smartphone 20 is present within the predetermined range.

In addition, terminal sensing section 207 of smartphone 20 determines whether or not electronic paper terminal 10 is present within the specific range (step 215). When electronic paper terminal 10 is present outside the specific range, terminal sensing section 207 notifies data management section 208 of the fact that electronic paper terminal 10 is present outside the specific range. Upon receiving the notification of the fact, data management section 208 deletes the material file (step 216). In addition, data management section 208 subsequently notifies the PC of a warning message (step 217).

As described above, according to the second exemplary embodiment, data management system 2 is a displaying system which includes paired smartphone 20 and electronic paper terminal 10, smartphone 20 being is a first mobile terminal, electronic paper terminal 10 being a second mobile terminal. Electronic paper terminal 10 includes display section 103, sensing section 107, and display control section 108. Sensing section 107 senses whether or not smartphone 20 is present within the predetermined range. When smartphone 20 is present outside the predetermined range, display control section 108 causes display section 103 to display the predetermined image. With this configuration, for example, when electronic paper terminal 10 is lost, and smartphone 20 becomes present outside the predetermined range, the displayed contents are rewritten, and the predetermined image is displayed. It is therefore possible to inhibit leakage of information more reliably.

In addition, according to the above exemplary embodiment, smartphone 20 includes storage section 205, which is a first storage section, and data management section 208. Storage section 205 stores data, and data management section 208 transmits the data stored in storage section 205 to electronic paper terminal 10 with display section 103 of electronic paper terminal 10 displaying page units one at a time. In addition, electronic paper terminal 10 further includes first communication section 101, which is a reception section, and storage section 105, which is a second storage section. First communication section 101 receives data from smartphone 20. Storage section 105 stores the data received from smartphone 20. Display section 103 has the display maintenance property of retaining the displayed contents without using electricity. Display control section 108 acquires data to be displayed display section 103 from smartphone 20 with display section 103 displaying page units one at a time, and display control section 108 causes display section 103 to display the data. In addition, upon causing display section 103 to display the data stored in storage section 105, display control section 108 deletes the displayed data from storage section 105. With this configuration, data to be stored in electronic paper terminal 10 is acquired with display section 103 displaying page units one at a time, and upon being displayed, the data is deleted. Therefore, for example, in the case where data contained in a material file is displayed portion by portion over multiple times, such as the case where a material file made up of several pages is displayed on electronic paper terminal 10, data items other than those used for display are not stored in electronic paper terminal 10. It is thereby possible to inhibit leakage of information more reliably.

In addition, according to the above exemplary embodiment, smartphone 20 further includes terminal sensing section 207 that senses whether or not electronic paper terminal 10 is present within the specific range. Then, when terminal sensing section 207 senses that electronic paper terminal 10 is present outside the specific range, data management section 208 deletes data stored in storage section 205. With this configuration, when electronic paper terminal 10 is present outside the predetermined range with respect to smartphone 20, the data stored in smartphone 20 is deleted. It is thereby possible to inhibit leakage of information more reliably when electronic paper terminal 10 is lost, as well as when smartphone 20 is lost.

In addition, according to the above exemplary embodiment, when electronic paper terminal 10 is present outside the specific range, data management section 208 of smartphone 20 transmits a warning message to PC 30, which is a predetermined external device. With this configuration, the warning message is displayed on PC 30 when electronic paper terminal 10 or smartphone 20 is lost. Therefore, even when the owner of electronic paper terminal 10 and smartphone 20 does not notice that electronic paper terminal 10 or smartphone 20 is lost, a warning message is displayed on PC 30. It is therefore possible to more reliably recognize the possibility that information may be leaked.

As above, the invention of the application has been described with reference to exemplary embodiments but is not limited to the above exemplary embodiments. The configurations and details of the invention of the application can be subjected to various modifications that can be understood by those skilled in the art within the scope of the invention of the application.

For example, in the above exemplary embodiments, it is assumed that the mobile terminal equipped with the display section is an electronic paper terminal having a display maintenance property, but the present invention is not limited to such an example. For example, the mobile terminal may be a device equipped with display section 103 that does not have a display maintenance property, and may be a device equipped with display section 103, other than electronic paper, that has a display maintenance property. For example, for display section 103, a technology other than electronic paper, such as liquid crystal memory, to retain displayed contents without using electricity may be employed. In addition, the scheme of the electronic paper is not limited, and any scheme including an electrophoresis scheme, and a micro electro mechanical system (MEMS) shutter scheme may be used as long as the scheme has a display maintenance property.

In addition, in the above second exemplary embodiment, it is assumed that electronic paper terminal 10 acquires a list of material files that are stored in smartphone 20 and that display the list on display section 103, but the present invention is not limited to such an example. For example, data on the first page of the material file selected by a smartphone 20 side may be displayed on electronic paper terminal 10.

In addition, in the above second exemplary embodiment, sensing section 107 of electronic paper terminal 10 senses whether or not smartphone 20 is present within the predetermined range. In addition, terminal sensing section 207 of smartphone 20 senses whether or not electronic paper terminal 10 is present within the specific range. Here, the predetermined range and the specific range may be the same, and may be different from each other depending on sensing methods.

In addition, the steps illustrated in the flowchart of FIG. 2 or the sequence diagram in FIG. 4 may be executed by a time series in the order as described, or may be executed in parallel. For example, step 104 and step 105 of FIG. 2 may be executed in parallel with step 102 or step 103. In addition, step 215 to step 217 of FIG. 4 may be executed in parallel with step 206 to step 214 after the execution of step 205. In addition, in some cases, the order of the steps processed by a time series also can be changed as appropriate.

In addition, the above exemplary embodiments are described mainly about configurations and the operation examples of electronic paper terminal 10 and smartphone 20, and it is possible to create computer programs for implementing the functions of electronic paper terminal 10 and smartphone 20. In addition, it is also possible to provide a computer-readable recording medium in which such computer programs are stored. In addition, the computer programs may be distributed, for example, over a network without using a recording medium.

As mentioned above, the present invention has been described with reference to exemplary embodiments but is not limited to the above exemplary embodiments. The configurations and details of the present invention can be subjected to various modifications that can be understood by those skilled in the art within the scope of the present invention.

This application is based upon and claims the benefit of priority from Japanese Patent Application No. 2014-65719, filed on Mar. 27, 2014, the disclosure of which is incorporated herein in its entirety by reference.

1. A mobile terminal comprising:
a display section that has a display maintenance property that eliminates the need to rely on electricity for retaining displayed contents;
a sensing section that senses whether or not a predetermined terminal device is present within a predetermined range; and
a display control section that causes said display section to display a predetermined image when the terminal device is present outside the range.

2. The mobile terminal according to claim 1, further comprising
a storage section that stores data to be displayed on said display section, wherein
when data stored in said storage section is displayed on said display section, said display control section deletes the displayed data from said storage section.

3. The mobile terminal according to claim 1, further comprising
a communication section that is connectable to the terminal device, wherein
said display control section acquires data to be displayed on said display section from the terminal device with said display section displaying page units one at a time, and said display control section causes said display section to display the data.

4. The mobile terminal according to claim 1, wherein the predetermined image contains contact address information of an owner of said mobile terminal.

5. A displaying system using a paired first mobile terminal and second mobile terminal, wherein
said second mobile terminal comprises:
a display section that has a display maintenance property that eliminates the need to rely on electricity for retaining displayed contents;
a sensing section that senses whether or not said first mobile terminal is present within a predetermined range; and
a display control section that causes said display section to display a predetermined image when said first mobile terminal is present outside the range.

6. The displaying system according to claim 5, wherein
said first mobile terminal comprises:
a first storage section that stores data; and
a data management section that transmits the data stored in said first storage section to said second mobile terminal with said display section of said second mobile terminal displaying page units one at a time,
said second mobile terminal further comprises:
a reception section that receives the data from said first mobile terminal; and
a second storage section that stores the data received from said first mobile terminal, wherein
when said first mobile terminal is present within the range, said display control section causes said display section to display data stored in said second storage section, and when said display section is caused to display the data stored in said second storage section, said display control section deletes the displayed data from said second storage section.

7. The displaying system according to claim 5, wherein
said first mobile terminal further comprises a terminal sensing section that senses whether or not said second mobile terminal is present within a specific range, and
when said second mobile terminal is present outside the specific range, said data management section deletes the data stored in said first storage section.

8. The displaying system according to claim 7, wherein said data management section transmits a warning message to a predetermined external device when the second mobile terminal is present outside the specific range.

9. A display controlling method comprising:
sensing whether or not a first mobile terminal is present within a predetermined range with respect to a second mobile terminal that comprises a display section that has a display maintenance property that eliminates the need to rely on electricity for retaining displayed contents; and
displaying a predetermined image on said display section when the first mobile terminal is present outside the range.

10. A recording medium in which a program is stored, said program causing a computer to execute the steps of:
sensing whether or not a first mobile terminal is present within a predetermined range with respect to a second mobile terminal that comprises a display section that has a display maintenance property that eliminates the need to rely on electricity for retaining displayed contents; and
displaying a predetermined image on said display section when the first mobile terminal is present outside the range.
